(19) United States
(12) Patent Application Publication
(10) Pub. No.: US 2016/0035010 A1
(43) Pub. Date: Feb. 4, 2016

(54) BINDING DIGITAL ASSETS TO A CONSUMER ORDER

(71) Applicant: Budsies LLC, Boynton Beach, FL (US)

(72) Inventor: Alex Furmansky, Boynton Beach, FL (US)

(21) Appl. No.: 14/810,513

(22) Filed: Jul. 28, 2015

Related U.S. Application Data
(60) Provisional application No. 62/030,807, filed on Jul. 30, 2014.

(51) Int. Cl. G06Q 30/06

(52) U.S. Cl. CPC G06Q 30/0635

(57) ABSTRACT

A customer order is process by software which provides a unique identification code to a customer, receives a unique digital image from the customer, and receives data from the customer corresponding to a customer order for a product fabricated is to resemble the unique digital image. The software associates the identification code with either the digital image or the customer order when providing the unique identification code, and receives an association of the identification code with the other of the digital image and the customer order later. The association can be derived from either input from the customer using a digital communication method or information identifying a computer of the user. Finally, the software later associates the unique digital image to the customer order using the unique identification code. The code enables the digital image and the order to be received at different times, using different sending methods.

### CROSS REFERENCE TO RELATED APPLICATIONS

This application claims the benefit of related U.S. Provisional Patent Application No. 62/030,807, filed Jul. 30, 2014, the contents of which are incorporated herein by reference in their entirety.

### FIELD OF THE DISCLOSURE

The disclosure relates to a system and method for digital order processing, and in particular, correlating order information and digital image content.

### BACKGROUND OF THE DISCLOSURE

For over a century, the world's production mechanization has shifted products from handmade crafts to mass produced, standardized units. Customers may walk into a retail establishment or, in recent years, visit an online storefront, and select an off-the-shelf product.

Merchants may allow customization of products by consumers while consumers are at a storefront. In physical, brick-and-mortar stores, this may be as simple as allowing customers to select their shoe size, or mix-and-match color combinations of charms on a necklace. For certain custom-made products, consumers may bring samples or sketches to the storefront to provide the manufacturer guidance for production. For example, a customer may bring a painting to a frame merchant such that the frame can be altered specifically to the dimensions of the painting.

In the online environment, merchants have provided customers with certain other customization options. For example, customers can specify color features of sneakers or specify monograms for bags. In certain cases, customers can upload a binary digital file for the manufacturer, for example a design for a business card, at the time of making a purchase.

A storefront may allow customers to separately send their assets via postage or via electronic mail to a generic acceptance address. An employee of the storefront then manually attempts to match the inbound asset to an existing item within an existing order. In some storefronts, customers are asked to mention a unique order number or customer number within their communication, which is used to match the assets with the order manually.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 depicts a customer interaction with a storefront;

FIG. 2 depicts creation of Unique Identification Code (“UIC”) of the disclosure for a specific current session of a product for a customer;

FIG. 3 depicts generating unique UICs in accordance with the disclosure, for product, customer, and session;

FIG. 4 depicts sending a binary file and UIC, by the customer, to a server, in accordance with the disclosure;

FIG. 5 depicts identification, in accordance with the disclosure, of the UIC and the customer order, by the server;

FIG. 6 depicts a web server of the disclosure accepting the binary file, creating a new UIC, and communicating the UIC to the customer;

FIG. 7 depicts a web server of the disclosure retrieving a binary file based on a UIC associated with a customer order.

FIG. 8 depicts a portion of an order entry web page, in which an ‘upload it’ selection has been made;

FIG. 9 depicts a portion of an order entry web page, in which an ‘email it’ selection has been made;

FIG. 10 depicts a portion of an order entry web page, in which a ‘text it’ selection has been made;

FIG. 11 is a flow diagram of a process of the disclosure;

FIG. 12 is a an example of a digital image of artwork of a customer;

FIG. 13 is an example of a three dimensional form fabricated using the digital image of FIG. 12; and

FIG. 14 depicts a computer system, all or parts of which can be used to carry out one or more portions of the disclosure.

### SUMMARY OF THE DISCLOSURE

In an embodiment of the disclosure, a method of processing a customer order, comprises using at least one computer server executing software stored on non-transitory media, the software configured for electronically receiving from the customer, during a web server session, at least one of (i) a digital image, (ii) order data, and (iii) an intention to submit a digital image, and (iv) an intention to submit order data, wherein the order data and digital image correspond to a customer order for a unique product, the product to be fabricated to resemble the digital image; generating and electronically providing the unique identification code to the customer when the customer communicates an intention to, at least one of, send the digital image at a later time period after the web server session has ended and send the order data at a later time period after the web server session has ended; associating the unique identification code and the received digital image with the received order data when the unique identification code is provided by the customer with the received digital image; and associating the unique identification code and the received order data with the received digital image when the unique identification code is provided by the customer with the received order data.

In variations thereof, the digital image is received before the customer order data is received; the customer order data is received before the digital image is received; the identification code is provided before the digital image or customer order data is received; the identification code is associated with information associated with the customer; the customer is information relating to a computer of the customer; and/or the digital image is a digital scan of artwork of the customer; the unique product is a three dimensional figure visually similar to the two dimensional digital image.

In additional variations thereof, the digital image is received by an MMS message; the identification code is provided by the customer using an MMS message; and/or the unique identification code is provided by the customer together with the digital image or the order data using an MMS message; the identification code is associated with information identifying the order data; and/or the identification code is associated with information identifying the digital image; the digital image is received by email; the email includes the identification code.

In another embodiment of the disclosure, a system for processing a customer order, comprises at least one computer server executing software stored on non-transitory media, the software configured for electronically receiving from the customer, during a web server session, at least one of (i) a digital image, (ii) order data, and (iii) an intention to submit a digital image, and (iv) an intention to submit order data, wherein the order data and digital image correspond to a customer order for a unique product, the product to be fabricated to resemble the digital image; generating and electronically providing the unique identification code to the customer when the customer communicates an intention to, at least one of, send the digital image at a later time period after the web server session has ended and send the order data at a later time period after the web server session has ended; associating the unique identification code and the received digital image with the received order data when the unique identification code is provided by the customer with the received digital image; and associating the unique identification code and the received order data with the received digital image when the unique identification code is provided by the customer with the received order data.

In variations thereof, the software including a website server and associated website pages; and/or the software including an application that is not a browser page, the application executable upon a handheld computing device.

In a further embodiment of the disclosure, a method of processing a customer order, comprises using at least one computer server executing software stored on non-transitory media, the software configured for electronically receiving from the customer, during a web server session, at least one of (i) a digital image corresponding to artwork of the customer, (ii) order data, and (iii) an intention to submit a digital image, and (iv) an intention to submit order data, wherein the order data and digital image correspond to a customer order for a unique stuffed fabric figure product, the product to be fabricated to resemble the digital image; generating and electronically providing the unique identification code to the customer when the customer communicates an intention to, at least one of, send the digital image at a later time period after the web server session has ended and send the order data at a later time period after the web server session has ended; associating the unique identification code and the received digital image with the received order data when the unique identification code is provided by the customer with the received digital image; and associating the unique identification code and the received order data with the received digital image when the unique identification code is provided by the customer with the received order data.

In a variation thereof, the digital image is a digital scan of the artwork of the customer.

### DETAILED DESCRIPTION OF THE DISCLOSURE

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

The disclosure utilizes the two-way digital communication enabled by the Internet as part of a method for creating unique custom-crafted products. While the disclosure can be used by manufacturers to communicate product details to the consumer, or to present simple customizations during checkout, the disclosure also enables consumers to communicate detailed and unique specifications not previously known to the manufacturer, directly to the manufacturer.

The process of the disclosure, in an embodiment, enables an automated and scalable method for customers to attach digital, binary assets to specific items in their order. More particularly, there are cases where the customer may wish to provide an asset to the manufacturer to help the manufacturer produce a custom product, but the customer does not have the asset (i) accessible or (ii) available at the time of purchase. The disclosure provides a method for providing digital assets or information asynchronously with respect to a time for making a purchase. The disclosure enables advantages to the consumer, including enhanced:
(i) accessibility: an example includes a customer ordering business cards through an online environment on a laptop, but transmitting their artwork later from a separate device for example a smartphone; and
(ii) availability: an example includes a customer ordering business cards through an online environment, but the artwork is not yet finalized and will be submitted later.

In accordance with the disclosure, methods of the prior art for correlating detail with an order have a much greater incidence of scalability problems and human error issues.

The disclosure enables a scalable, asynchronous processing of one or more binary files sent by the consumer to the merchant, to be related to a specific product ordered by the consumer, using any electronic communication device. In an embodiment, a web server creates a Unique Identification Code (“UIC”) in real time for each variant of a product type created by the customer. This UIC is unique to the (i) specific product (ii) specific customer (iii) and specific session.

In accordance with the disclosure, an ordering server session time period corresponds to (a) a web server session established by a web server during which variables are stored until a transaction has been completed, or a timeout period occurs during which no input is received, or the transaction has not been completed within a predetermined time period, which is typically short, for example a few minutes up to an hour, or (b) any time period where the current transaction, which is part of an ordering process, has been concluded. Period (b) could be met when a user logs off of a website, or simply stops using it having concluded a desired activity. Alternatively, period (b) can correspond to an in-person order at a physical store, which is terminated when the customer has left, or a substantial period of time has elapsed after a customer has completed part of an ordering process, for example after the customer has providing all needed ordering information, not including the digital image. It should be understood that the ordering server session is a discrete part of a complete order of the disclosure, wherein the entire order, including providing one or more images, can be carried out over an unlimited period of time, but is typically completed within days, weeks, or months.

When a customer sends the binary file associated with an item in their order, they include the UIC within their communication. The web server recognizes the UIC and matches it to the corresponding UIC stored on the web server. The web server than binds the binary file to the specific item of that specific customer's order without human intervention. The merchant now has the customer's details for completing the order.

The customer order, to which the UIC is bound, includes information pertaining to the customer, including for example a name, contact information, and payment information, as well as a description of the products or services desired. The product information can include a size, materials desired, allergy information, color, or any other information relevant to defining the product or service desired. Other order information can include the time needed, shipping preference, or any other information associated with a customer order for a product or service.

The interaction between customer and merchant, whereby the customer provides a binary file, to be associated with the order, to the merchant, may occur over any digital communication medium, and may occur asynchronously with the order checkout process. More particularly, the customer can send the digital file before, during, or after completing an online storefront checkout portion of the process.

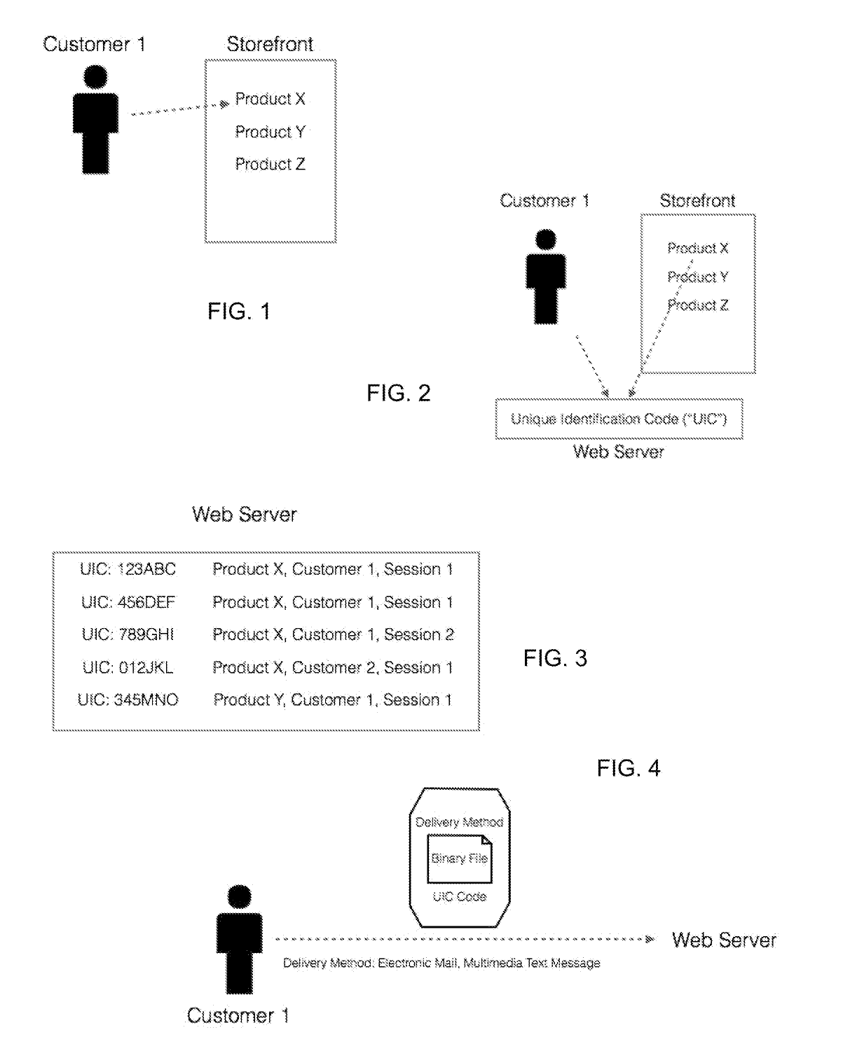

With reference to FIG. 1, a system of the disclosure enables customers to send one or more binary files to an online storefront related to a specific item or items in their order. Further, the system enables the storefront to capture the binary file without human assistance or intervention, and to correlate the binary file to a specific item within the customer's order, and to thereby continue the purchase or fulfillment process associated with the order and binary files. The binary file can be a digital image or photograph, or a scan of any image or photo. The image can be a sketch, for example a child's drawing, or other unique artwork, or any other image which is to be used or referenced in order to carry out the customer's order to produce a product or service.

With reference to FIGS. 1-3, in accordance with an embodiment of the disclosure, a customer initiates interaction with software of the disclosure, for example using an application or website of the disclosure, communicating with a web server of the disclosure, to specify a product in an online storefront (FIG. 1) for a transaction. The web server creates a Unique

Identification Code (“UIC”) for the specific session of the customer interacting with specific product (FIG. 2). Individual UICs are generated for each new combination of customer, product, and session (FIG. 3). The UIC can be a randomly selected number, sequence of letters and numbers, symbols, or any other designation, or the UIC can additionally or alternatively encode particular information associated with the transaction. A database associated with the web server correlates information not stored within the UIC with other information associated with the transaction.

With reference to FIGS. 4-6, the customer can send the binary file, related to the customer's purchase of the specific product, to a web server of the disclosure that is associated with the storefront (FIG. 4). The file may be sent via any electronic communication mechanism, such as electronic mail or multimedia text message, including for example MMS, or a method hereinafter developed. The file may be any binary file, including for example a photo or video stored as a bitmap, vector graphic file, or an image encoding text file, such as XML or Postscript. The UIC is included within the electronic communication mechanism, such as in header information, in the message body, or in a message envelope, and can be separate from the binary file, such as within the subject line of an electronic mail message or the body of multimedia text message. While it is possible to encode the UIC within the binary data, this is not necessary, but could additionally or alternatively be carried out in accordance with the disclosure. The UIC may also be used to encode the digital address of the storefront, such as the electronic email address or the phone number where the multimedia text message is to be sent.

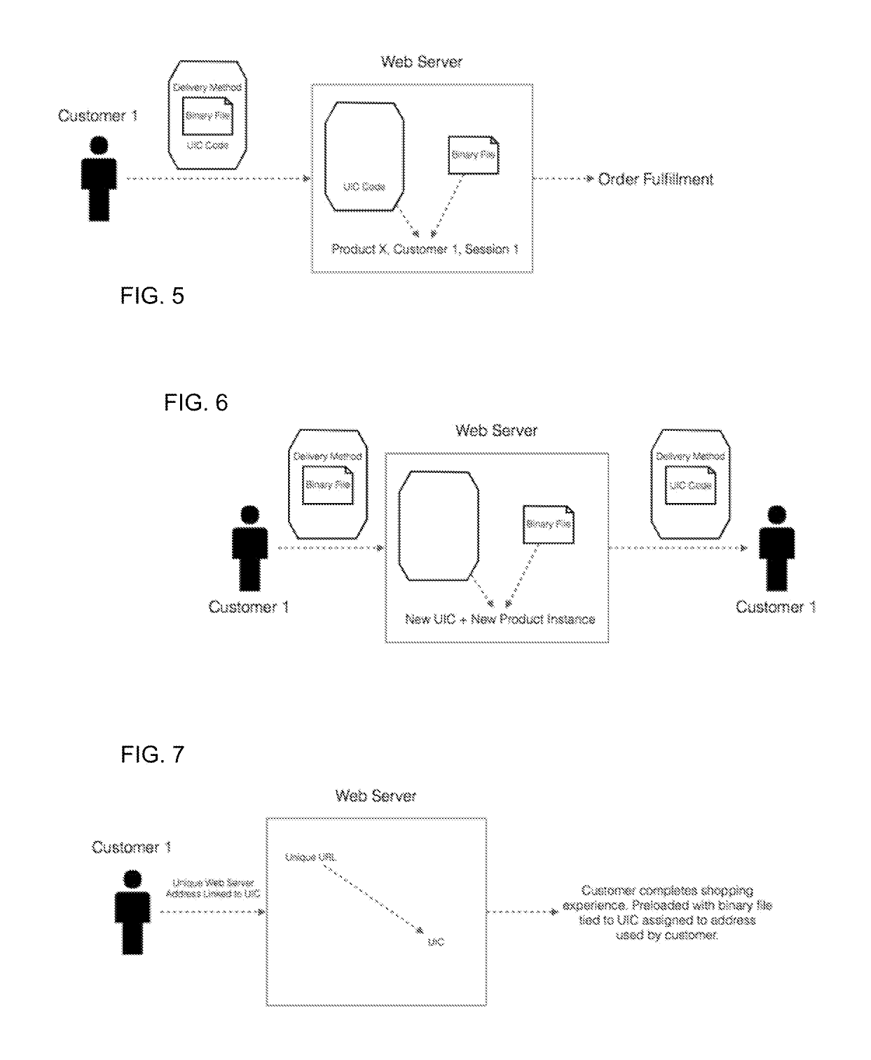

When the UIC and binary file are sent at a time later than when the original order was generated, then upon receipt of the message, the web server identifies the UIC within the message (FIG. 5), and retrieves the binary file. The binary file is placed in storage within the web server, or within storage available to the web server. The UIC is interpreted if encoding data, or is otherwise matched to the UIC from the associated order pertaining to the initial customer interaction with the storefront. Alternatively, the UIC is stored until other portions of the order process have been carried out, for example all aspects of the order have been completed, or all binary files have been received. When the order is ready to be processed, the binary file is bound to the specific product within the specific correlating customer shopping session. The merchant may now proceed with further order processing, including for example custom fabrication pursuant to the digital data, and/or fulfillment of the order.

In an embodiment, the UIC is matched with an order that is created entirely after the UIC has been generated, wherein the UIC is generated and given to the customer based merely upon sufficient information to identify the customer. In a still further embodiment, the UIC is not identified with any customer when it is generated. In this manner, a plurality of individuals or companies can submit order information and binary files to be combined to produce a complete order at a time after issuance of the UIC.

The process of accepting and binding the binary file to the customer's order may be completed asynchronously from the customer placing his/her order. Thus, the customer can (i) be visiting the online storefront at the time the file is sent, (ii) send the file after visiting the storefront, or (iii) send the file before visiting the storefront. In accordance with the disclosure, a storefront is either a physical store location, or an online portal, including for example an internet website. Additionally, a plurality of image or binary files can each be sent at any of the aforedescribed time periods, and all files are associated by the UIC with an order, or a particular item on an order.

In the case of option (ii) of the preceding paragraph, the customer may have already completed all other portions of the order checkout process, or the customer may need to visit the online storefront again to complete the checkout process, for example to make payment. In an embodiment, payment is made by a person who did not originally create the order.

In the case of option (iii), the customer can send the binary file to the storefront first. In accordance with the disclosure, the web server either (i) recognizes the lack of UIC in the customer's communication or (ii) reads a command within the electronic communication mechanism indicating a preference for the creation of a new UIC. For example, the command can be designated by the customer/consumer, or can be generated by software within the client or server in recognition of the order screen chosen, or the lack of a UIC. In either case, the customer is causing the instantiation of a new electronic session, corresponding to a particular product type available in the online storefront, and a new UIC is created in association with the customer's selection of product (FIG. 6).

Further in the case of option (iii), the web server can generate a unique address (such as a URL) and deliver this address to the customer instead of UIC data. When a customer accesses the web server using this specific URL, the web server decodes the URL to reveal the matching UIC, or otherwise correlates the URL with its corresponding UIC, and thus identifies the original binary file sent by the customer. The customer is thus able to visit the online storefront and complete a checkout, whereby the product in the transaction has already been designated, and associated with the customer, session, and the existing binary file. (FIG. 7).

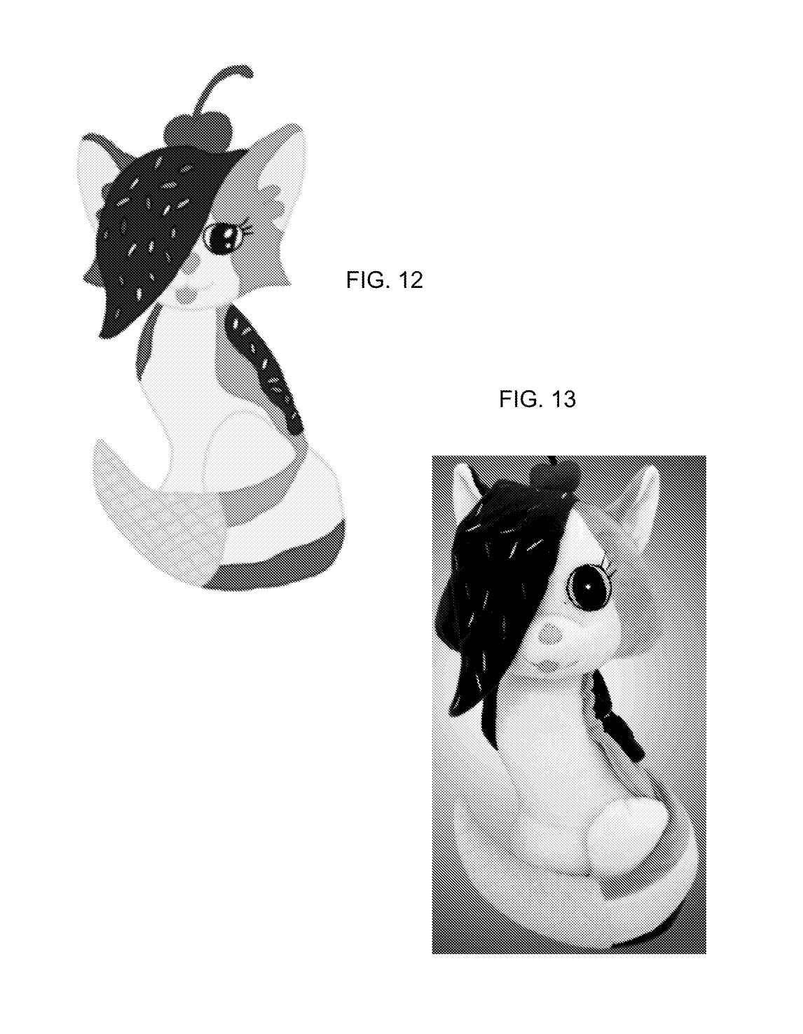

In one embodiment, a digital image of a two dimensional figure, for example a digital photograph of a child's drawing, is sent by MMS using the UIC. The digital image is associated with ordering information by a computer server using the UIC. A designer, who will produce a product based upon the digital photo and the order, can see both the child's drawing and the order information, and can begin to process the order and digital photograph to produce a three dimensional interpretation of the two dimensional photograph. In an embodiment, the three dimensional interpretation is a stuffed animal, as shown for example in FIG. 13, which is a three dimensional representation of the two dimensional drawing of FIG. 12, or a toy of other shape, or any other figure, to be made using fabric and a filling material. In another embodiment, the three dimensional interpretation can be in the form of a figurine which may be printed using a three dimensional printer. The designer may use the digital image and any additional descriptions accompanying the order to select the proper fabric or materials, style, color, shape, and accessories. Any of a plurality of fabrication workers, including for example designers, cutters, and sewing experts, may utilize the software and system of the disclosure to create three dimensional objects based upon customer submitted images.

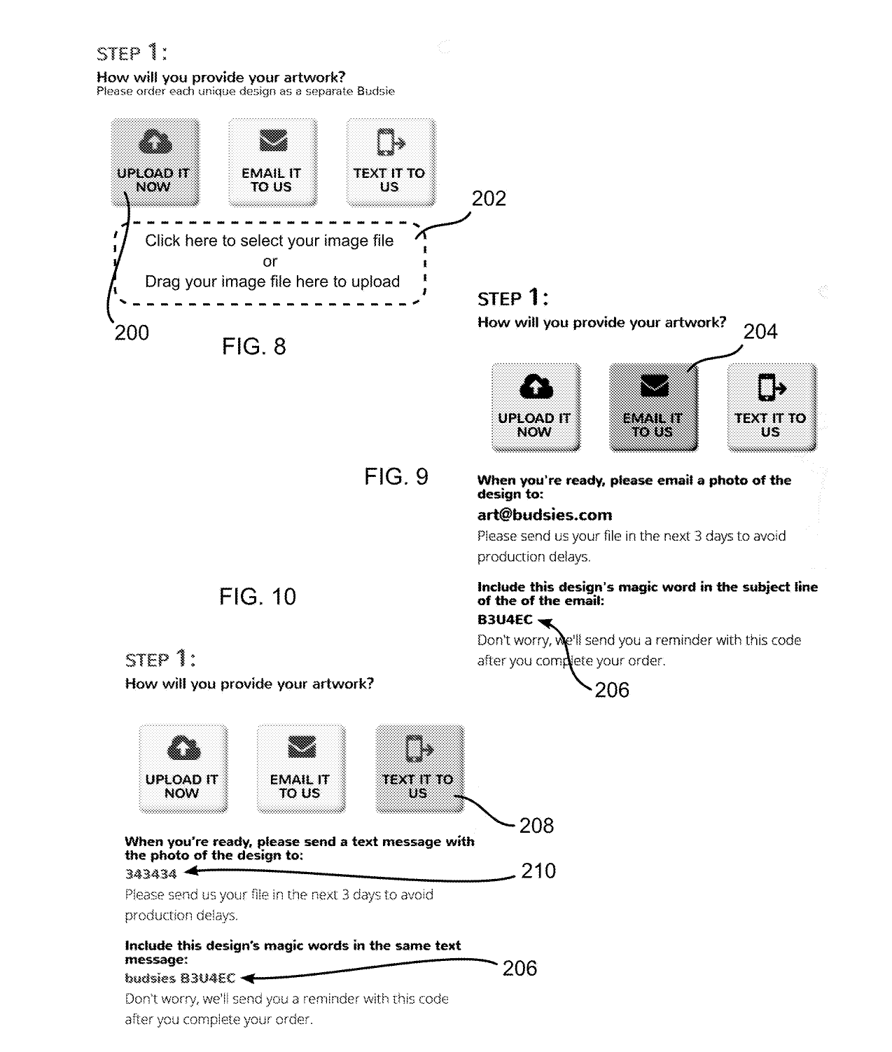

An example of the foregoing is provided in FIGS. 8-10, which depict portions of a web page ordering system in accordance with the disclosure. In FIG. 8, an option for uploading the image file is triggered by clicking an ‘upload it now’ button 200, whereupon a drop zone 202 is created on the page, which may also be clicked to open a dialog for selecting the upload file from a resource connected to the user's computer system. In FIG. 9, an ‘email it to us’ button 204 has been clicked, and instructions have been provided to the user regarding an address for the email which is to have the attached image file, as well as UIC 206 which is to be transcribed into the subject line of the email. In FIG. 10, a ‘text it to us’ button has been clicked, and instructions have been provided to the user regarding a text address 210 to send the image to, as well as UIC 206 which is included as text within the message containing the image.

In FIG. 8, a server of the disclosure receives the artwork together with the order. It should be understood that an ‘upload it later’ option can be provided, in which UIC 206 can be provided for uploading the image using the website at a later time.

With respect to FIGS. 9 and 10, a server of the disclosure receives the image/artwork at a later time, which can be significantly later, even months or years, after the order has been placed. The server correlates the UIC with the original order when the image and UIC are received, and the order is processed as described elsewhere herein.

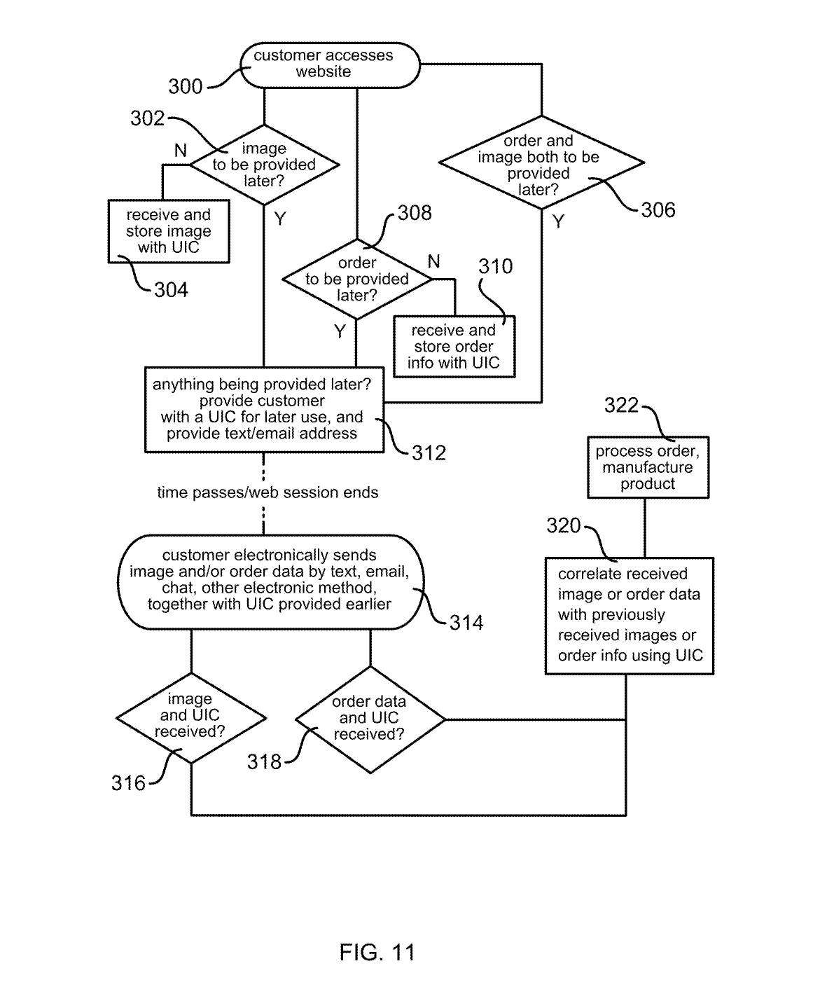

FIG. 11 is a flow diagram of a process of the disclosure for correlating a UIC with an order. More particularly, in an embodiment of the disclosure, processing a customer order which begins with a customer accessing a website hosted by a web server of the disclosure using a browser connected to the internet or other network at 300. The customer indicates whether he will provide an image later 302, provide order data later 308, or provide both the order and image later 306. It should be understood that the customer may explicitly state these intentions, or may implicitly do so. For example, as shown in FIGS. 8-9, selecting various options, such as ‘email it to us’, an indication is made that the artwork or image will be provided later. Similarly, if an image is uploaded during a current session, but no order data is provided, a UIC will be provided to the customer at the time of uploading the image. If order data is provided during the current session, there is no need to use the UIC unless one or more additional images will be provided later. The UIC may alternatively be used to re-access previously entered order information for reference or for making changes. If the order or image is to be provided during a current session, they are received and stored in 304 and 308, respectively.

In 312, if either or both of the image and order data are to be provided later, a UIC is provided. Advantageously, for simplicity, the same UIC and only a single UIC is provided during the session. As indicated in FIG. 11, time passes and it becomes no longer possible to upload an image or order information during the current ordering session. Accordingly, it will be necessary to indicate to a web server of the disclosure that an image or order data to be provided is to be correlated to a previously provided image or order data, or to an image or order data that was or will be provided after the session has ended, and which will be provided separately, at a different time, or using a different electronic method.

For example, if during the initial session neither an image nor order data is provided, a UIC is provided if the customer indicates an intention to send an image or order data later. Thus, later, an image can be uploaded at 314, for example, using a mobile phone that has taken a picture of the artwork, and the picture can be sent by MMS. A text address is provided by a web server of the disclosure when the UIC is provided, so that the customer can know the address to which the image and UIC should be texted to. Advantageously, the image and UIC are sent in one message transmission, although in embodiments a server of the disclosure can determine that an image and UIC sent close in time from a particular phone address are associated.

After the image or order data are received at 316, 318, they are correlated with any previously received image or data using the UIC, or are correlated with each other if neither has previously been received, using the UIC. Finally, the order is processed and manufactured at 322.

Exemplary Computer System

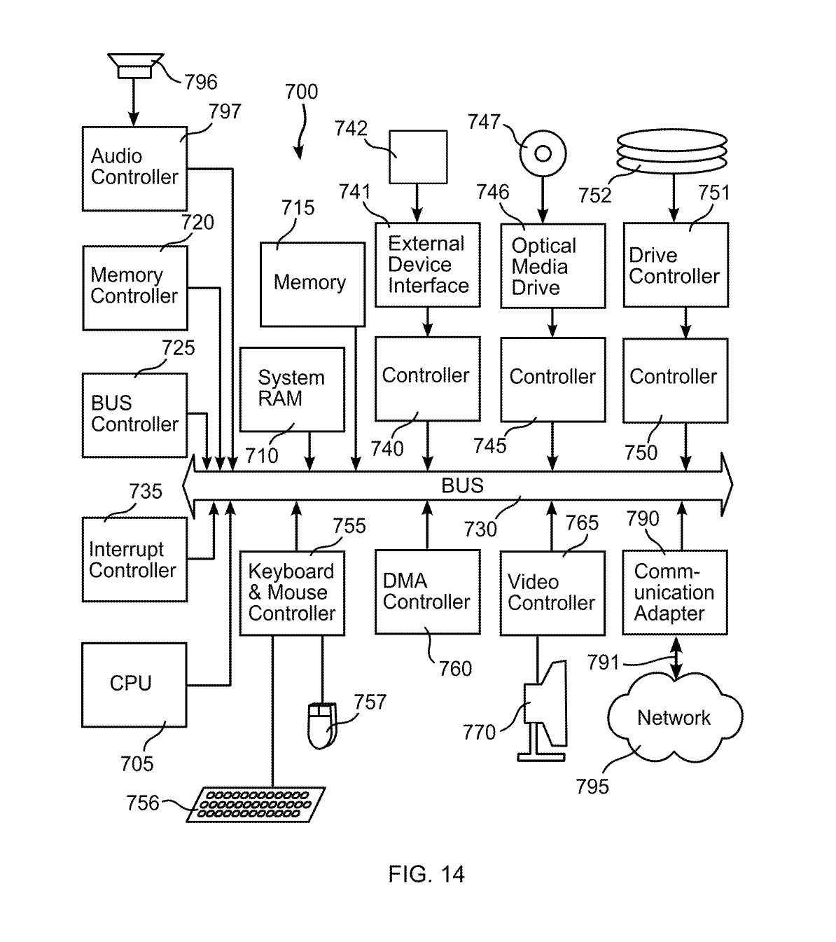

FIG. 14 illustrates the system architecture for a computer system 700, such as a process controller, or other processor on which or with which the disclosure may be implemented. The exemplary computer system of FIG. 14 is for descriptive purposes only. Although the description may refer to terms commonly used in describing particular computer systems, the description and concepts equally apply to other systems, including systems having architectures dissimilar to FIG. 14. Computer system 700 can control temperatures, motors, pumps, flow rates, power supplies, ultrasonic energy power generators, and valves, using actuators and transducers. One or more sensors, not shown, provide input to computer system 700, which executes software stored on non-volatile memory, the software configured to received inputs from sensors or from human interface devices, in calculations for controlling system 200.

Computer system 700 includes at least one central processing unit (CPU) 705, or server, which may be implemented with a conventional microprocessor, a random access memory (RAM) 710 for temporary storage of information, and a read only memory (ROM) 715 for permanent storage of information. A memory controller 720 is provided for controlling RAM 710.

A bus 730 interconnects the components of computer system 700. A bus controller 725 is provided for controlling bus 730. An interrupt controller 735 is used for receiving and processing various interrupt signals from the system components.

Mass storage may be provided by DVD ROM 747, or flash or rotating hard disk drive 752, for example. Data and software, including software 400 of the disclosure, may be exchanged with computer system 700 via removable media such as diskette, CD ROM, DVD, Blu Ray, or other optical media 747 connectable to an Optical Media Drive 746 and Controller 745. Alternatively, other media, including for example a media stick, for example a solid state USB drive, may be connected to an External Device Interface 741, and Controller 740. Additionally, another computing device can be connected to computer system 700 through External Device Interface 741, for example by a USB connector, BLUETOOTH connector, Infrared, or WiFi connector, although other modes of connection are known or may be hereinafter developed. A hard disk 752 is part of a fixed disk drive 751 which is connected to bus 730 by controller 750. It should be understood that other storage, peripheral, and computer processing means may be developed in the future, which may advantageously be used with the disclosure.

User input to computer system 700 may be provided by a number of devices. For example, a keyboard 756 and mouse 757 are connected to bus 730 by controller 755. An audio transducer 796, which may act as both a microphone and a speaker, is connected to bus 730 by audio controller 797, as illustrated. It will be obvious to those reasonably skilled in the art that other input devices, such as a pen and/or tablet, Personal Digital Assistant (PDA), mobile/cellular phone and other devices, may be connected to bus 730 and an appropriate controller and software, as required. DMA controller 760 is provided for performing direct memory access to RAM 710. A visual display is generated by video controller 765 which controls video display 770. Computer system 700 also includes a communications adapter 790 which allows the system to be interconnected to a local area network (LAN) or a wide area network (WAN), schematically illustrated by bus 791 and network 795.

Operation of computer system 700 is generally controlled and coordinated by operating system software, such as a Windows system, commercially available from Microsoft Corp., Redmond, WA. The operating system controls allocation of system resources and performs tasks such as processing scheduling, memory management, networking, and I/O services, among other things. In particular, an operating system resident in system memory and running on CPU 705 coordinates the operation of the other elements of computer system 700. The present disclosure may be implemented with any number of commercially available operating systems.

One or more applications, such as an HTML page server, or a commercially available communication application, may execute under the control of the operating system, operable to convey information to a user.

It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

What is claimed is:

1. A method of processing a customer order, comprising:
using at least one computer server executing software stored on non-transitory media, the software configured for:
electronically receiving from the customer, during a web server session, at least one of (i) a digital image, (ii) order data, and (iii) an intention to submit a digital image, and (iv) an intention to submit order data, wherein the order data and digital image correspond to a customer order for a unique product, the product to be fabricated to resemble the digital image;
generating and electronically providing the unique identification code to the customer when the customer communicates an intention to, at least one of, send the digital image at a later time period after the web server session has ended and send the order data at a later time period after the web server session has ended;
associating the unique identification code and the received digital image with the received order data when the unique identification code is provided by the customer with the received digital image; and
associating the unique identification code and the received order data with the received digital image when the unique identification code is provided by the customer with the received order data.

2. The method of claim 1, wherein the digital image is received before the customer order data is received.

3. The method of claim 1, wherein the customer order data is received before the digital image is received.

4. The method of claim 1, wherein the identification code is provided before the digital image or customer order data is received.

5. The method of claim 4, wherein the identification code is associated with information associated with the customer.

6. The method of claim 5, wherein the information associated with the customer is information relating to a computer of the customer.

7. The method of claim 1, wherein the digital image is a digital scan of artwork of the customer.

8. The method of claim 1, wherein the unique product is a three dimensional figure visually similar to the two dimensional digital image.

9. The method of claim 1, wherein the digital image is received by an MMS message.

10. The method of claim 1, wherein the identification code is provided by the customer using an MMS message.

11. The method of claim 1, wherein the unique identification code is provided by the customer together with the digital image or the order data using an MMS message.

12. The method of claim 1, wherein the identification code is associated with information identifying the order data.

13. The method of claim 1, wherein the identification code is associated with information identifying the digital image.

14. The method of claim 1, wherein the digital image is received by email.

15. The method of claim 14, wherein the email includes the identification code.

16. A system for processing a customer order, comprising:
at least one computer server executing software stored on non-transitory media, the software configured for:
electronically receiving from the customer, during a web server session, at least one of (i) a digital image, (ii) order data, and (iii) an intention to submit a digital image, and (iv) an intention to submit order data, wherein the order data and digital image correspond to a customer order for a unique product, the product to be fabricated to resemble the digital image;
generating and electronically providing the unique identification code to the customer when the customer communicates an intention to, at least one of, send the digital image at a later time period after the web server session has ended and send the order data at a later time period after the web server session has ended;
associating the unique identification code and the received digital image with the received order data when the unique identification code is provided by the customer with the received digital image; and
associating the unique identification code and the received order data with the received digital image when the unique identification code is provided by the customer with the received order data.

17. The system of claim 16, the software including a website server and associated website pages.

18. The system of claim 16, the software including an application that is not a browser page, the application executable upon a handheld computing device.

19. A method of processing a customer order, comprising:
using at least one computer server executing software stored on non-transitory media, the software configured for:
electronically receiving from the customer, during a web server session, at least one of (i) a digital image corresponding to artwork of the customer, (ii) order data, and (iii) an intention to submit a digital image, and (iv) an intention to submit order data, wherein the order data and digital image correspond to a customer order for a unique stuffed fabric figure product, the product to be fabricated to resemble the digital image;
generating and electronically providing the unique identification code to the customer when the customer communicates an intention to, at least one of, send the digital image at a later time period after the web server session has ended and send the order data at a later time period after the web server session has ended;
associating the unique identification code and the received digital image with the received order data when the unique identification code is provided by the customer with the received digital image; and
associating the unique identification code and the received order data with the received digital image when the unique identification code is provided by the customer with the received order data.

20. The method of claim 19, wherein the digital image is a digital scan of the artwork of the customer.
